(19) United States
(12) Patent Application Publication
(10) Pub. No.: US 2014/0007816 A1
(43) Pub. Date: Jan. 9, 2014

(54) SYSTEMS AND METHODS FOR CONTROLLING THE ENVIRONMENTS OF PET HABITATS

(71) Applicants: Elle B. Falahat, Danville, CA (US); Alejandro Bassi, Los Gatos, CA (US)

(72) Inventors: Elle B. Falahat, Danville, CA (US); Alejandro Bassi, Los Gatos, CA (US)

(21) Appl. No.: 13/863,371

(22) Filed: Apr. 15, 2013

Related U.S. Application Data
(60) Provisional application No. 61/624,886, filed on Apr. 16, 2012.

(51) Int. Cl. A01K 1/00

(52) U.S. Cl. CPC A01K 1/0052
USPC 119/500

(57) ABSTRACT

The present invention relates to systems and methods for controlling the environment of pet habitats. In one embodiment, an environmentally-controlled pet habitat includes a base, a forced-air inlet and a forced-air guide. The base is configured to accommodate a pet. The forced-air inlet is coupled to a forced-air outlet of a building ventilation system. The forced-air guide is coupled to the forced-air inlet and directs airflow substantially toward the base. The pet habitat may include a riser for supporting the forced-air guide and enabling the forced-air guide to direct airflow toward the base. The pet habitat may also include a cover and an auxiliary environmental controller.

This non-provisional application claims the benefit of provisional application No. 61/624,886 filed on Apr. 16, 2012, entitled “Systems and Methods for Controlling the Environments of Pet Habitats”, which application is incorporated herein in its entirety by this reference.

### BACKGROUND

The present invention relates generally to pet habitats. More particularly, this invention relates to environmentally-controlled user-configurable pet habitats. Such pet habitats can be configured to meet the particular needs of different pet owners, thereby providing comfort for the pet while also providing increased flexibility for the pet owners.

Typical indoor pet habitats include bean bags and kennel-like enclosures. All these traditional habitats suffer from one or more disadvantages including poor ventilation, stale odors, bulkiness and other unhealthy or undesirable characteristics.

Generally, the environment of these pet habitats cannot be adjusted without changing the environment of the entire building or room housing these pet habitats. Hence, environmental options for the pet owners and their pets are severely limited resulting in undesirable tradeoffs.

It is therefore apparent that a need exists for environmentally-controlled user-configurable pet habitats. These improved pet habitats will enable pet owners to easily configure the respective environments of these pet habitats, enabling optimization of pet comfort without compromising the comfort of the pet owners.

### SUMMARY

To achieve the foregoing and in accordance with the present invention, systems and methods for controlling the environment of pet habitats is provided. In particular these systems and methods for controlling the environments of user- configurable pet habitats address the particular needs of different pet owners, thereby providing comfort for the pet while also providing increased flexibility for the pet owner.

In one embodiment, an environmentally-controlled pet habitat, useful in association with a forced-air ventilation system of a building, includes a base, a forced-air inlet and a forced-air guide. The base is configured to accommodate a pet. The forced-air inlet is coupled to a corresponding forced-air outlet of a building ventilation system. The forced-air guide is coupled to the forced-air inlet and configured to direct airflow substantially toward the base.

In some embodiments, the environmentally-controlled pet habitat also includes a riser configured to support the forced-air guide thereby enabling the forced-air guide to direct airflow substantially downwards toward the base. The ventilation system can be a heating ventilation and cooling (HVAC) system, and can include a heater, an air cooler, an air chiller, a blower and/or an air conditioner.

The pet habitat can also include a cover constructed from mesh material and/or an insulated material. The cover can include an opening enabling the pet to enter and leave the pet habitat. The opening of the cover can be secured using fasteners such as a magnetic button, a Velcro strip or a zipper.

The pet habitat may also include an auxiliary environmental controller having one or more of a fan, a heater, an air conditioner, an air chiller, a humidifier, a filter, a freshener, a scent remover, a deodorizer and a disinfectant.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a perspective view of one embodiment of an environmentally- controllable pet habitat in accordance with the present invention;

FIG. 2 is an exploded view illustrating exemplary components for the embodiment of FIG. 1;

FIG. 3 is a cross-sectional view illustrating exemplary airflow pattern for the embodiment of FIG. 1 located proximate to an air outlet of a building;

FIGS. 4A and 4B are two perspective views of another embodiment of a climate-controlled pet habitat with an auxiliary control unit;

FIG. 5A is a perspective view of a habitat cover with the embodiment of FIG. 1;

FIGS. 5B and 5C are perspective views illustrating alternate covers with the embodiment of FIG. 1;

FIGS. 6A and 6B show yet another two variants of the pet habitat wherein the air outlet of the building is located on a substantially vertical surface such as a wall; and

FIG. 7 is a perspective view showing yet another embodiment of an environmentally-controlled pet habitat in accordance with the present invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

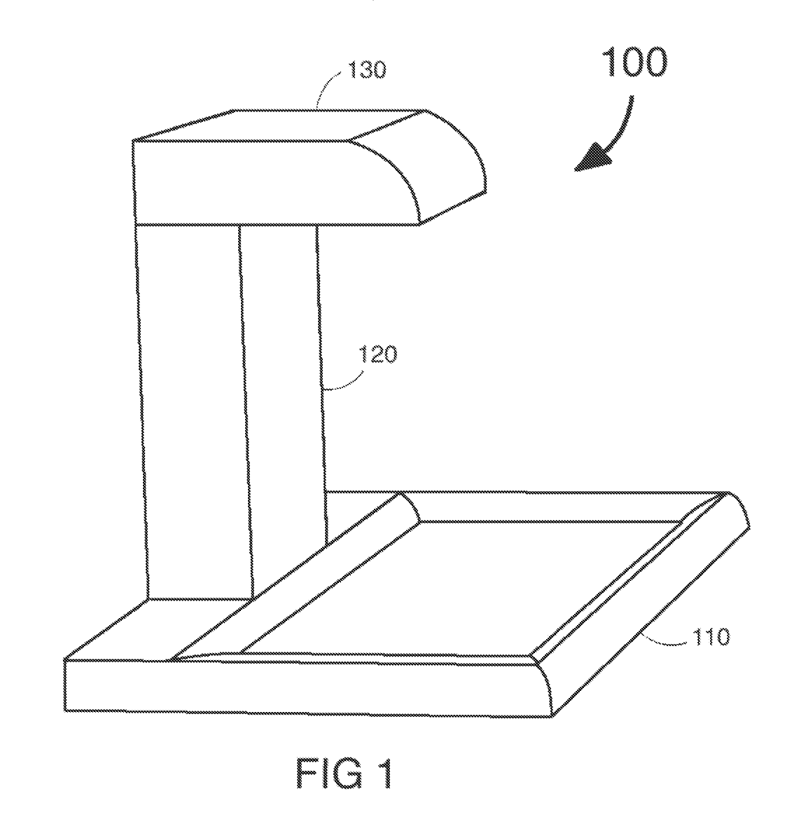

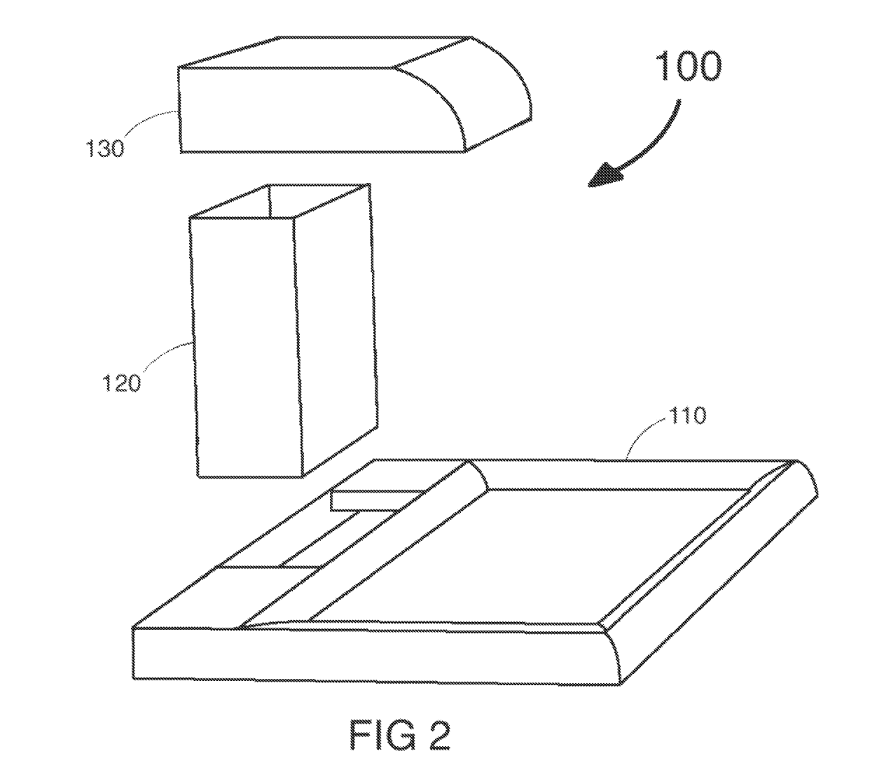

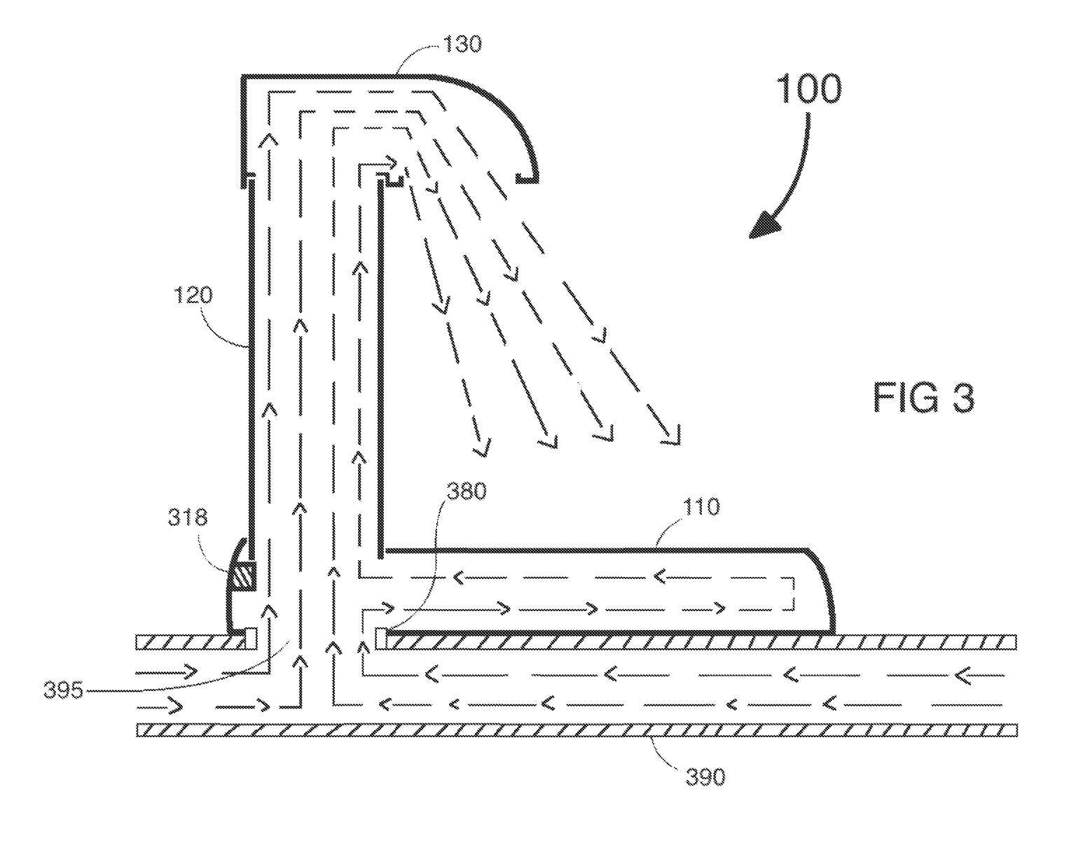

The present invention relates to systems and methods for controlling the environments of user-configurable pet habitats. To facilitate discussion, FIGS. 1-3 illustrate one embodiment of an environmentally-controllable pet habitat 100 in accordance with the present invention. FIGS. 1 and 2 are assembled and exploded views, respectively, showing the components of habitat 100. FIG. 3 is a cross-sectional view illustrating exemplary airflow pattern for habitat 100 located substantially on top of a forced-air outlet 380 of a building's ventilation system (not shown).

As shown in FIGS. 1 and 2, pet habitat 100 includes a base 110, a riser 120 and a hood 130. Habitat 100 is assembled by coupling the bottom opening of hollow riser 120 into a corresponding recess of base 110. The hood 130 is then coupled to the top opening of riser 120, thereby completing the assembly and forming an air channel from the base 110 to the hood 130.

Referring now to the cross-sectional view of FIG. 3, with pet habitat 100 located substantially over an upward facing forced-air outlet, e.g., floor register 380, forced air can flow from air duct 390 to hood 130, via register 380, base 110 and riser 120. Hence a pet (not shown) can rest comfortably on base 110 with supplemental airflow directed by hood 130.

Depending on the design and size of base 110, a portion of the environmentally-controlled airflow can be directed under base 110, as shown in FIG. 3. Additional optional baffles and/or vents can be added to base 110, or to further customize the airflow of habitat 100.

Although the described base 110 has a rectangular/square shape, base 110 can be customizable into various shapes and sizes. Base 110 can also be user configurable, for example, extendable to increase the length and/or width to accommodate a growing pet. Suitable shapes for habitat bases (not shown) include round, elliptical and polygonal shapes. Further, riser 120 can also have an adjustable riser height, e.g., a telescoping riser (not shown).

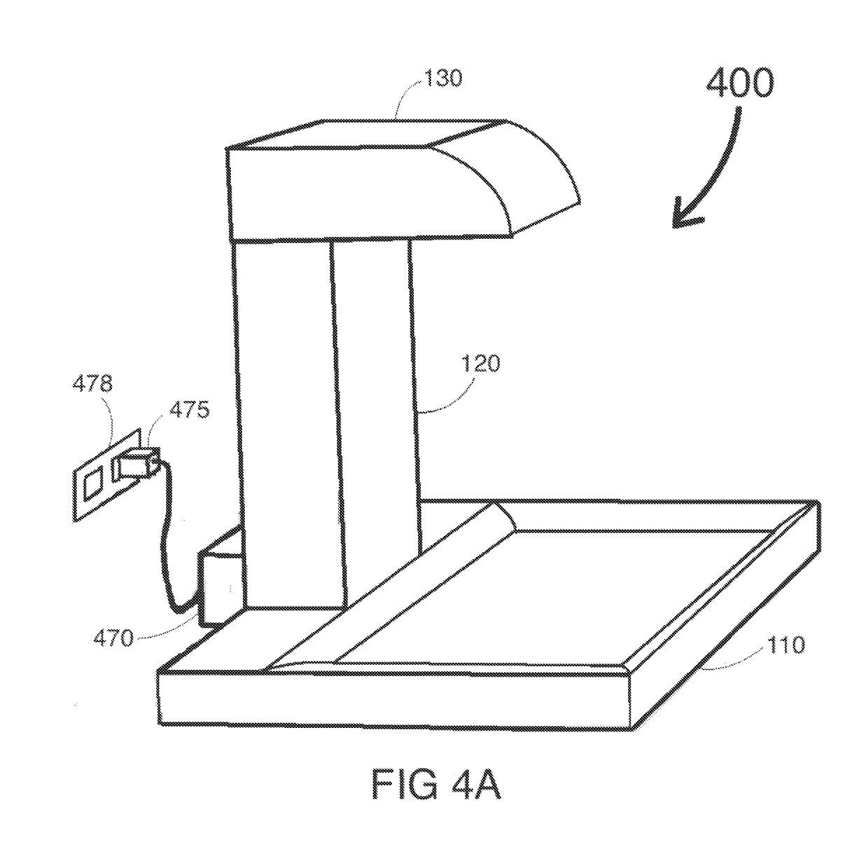

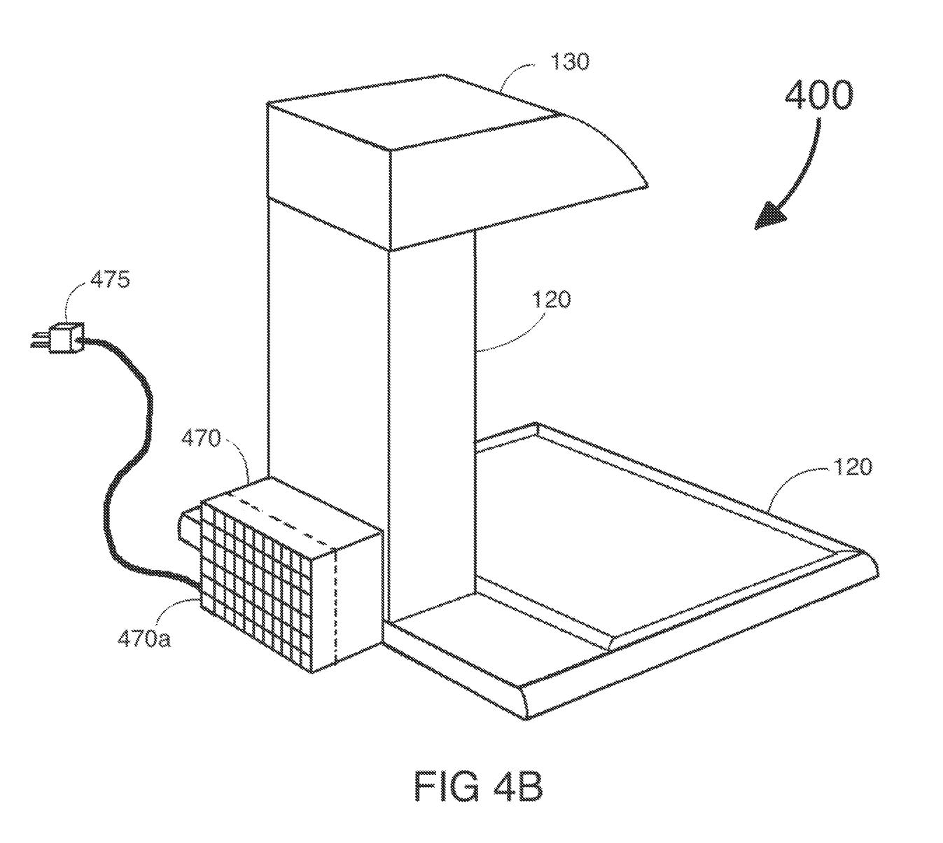

As shown in FIGS. 4A and 4B, two different perspective views of another embodiment of an environmentally-controlled pet habitat 400, an auxiliary environmental controller 470 is operatively coupled to one or more of base 110, riser 120 and hood 130. Power for auxiliary controller 470 can be provided via electrical plug 475 and wall outlet 478. Auxiliary environmental controller 470 can include one or more of these components, a fan, a heater, an air conditioner, an air chiller, a humidifier, an air filter, an air freshener, an aromatherapy dispenser, a scent remover, a deodorizer and a disinfector. Note that environmental controller 470 can function as the primary environment controller for pet habitat 400 when there is no airflow from the building.

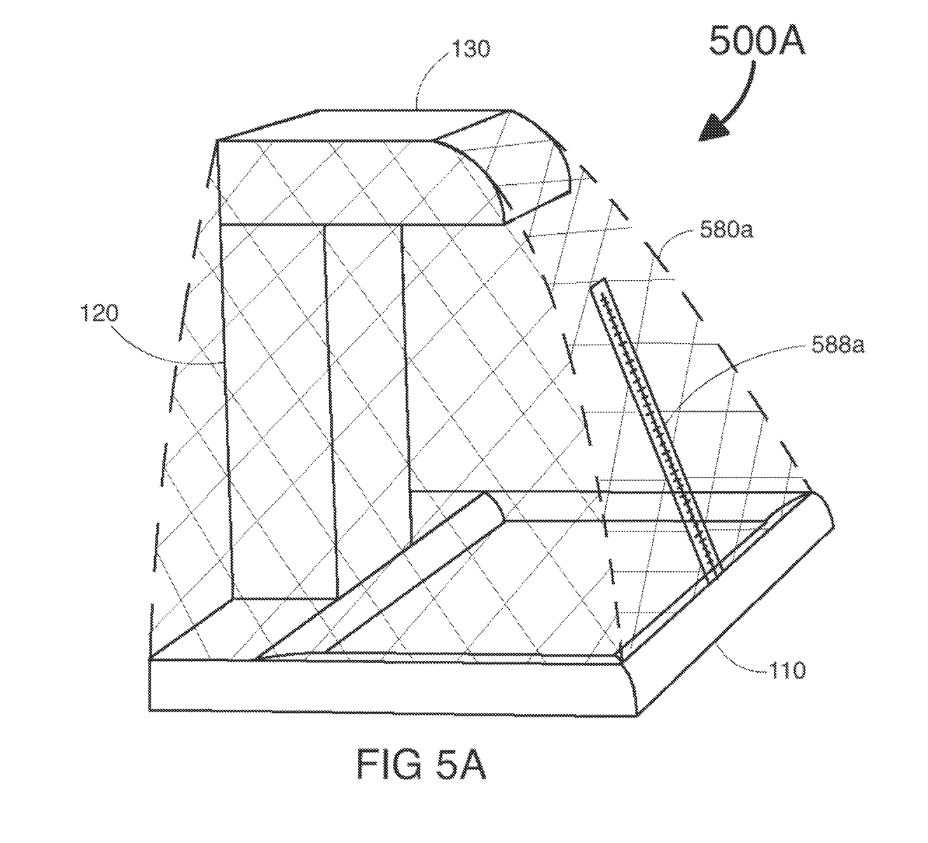

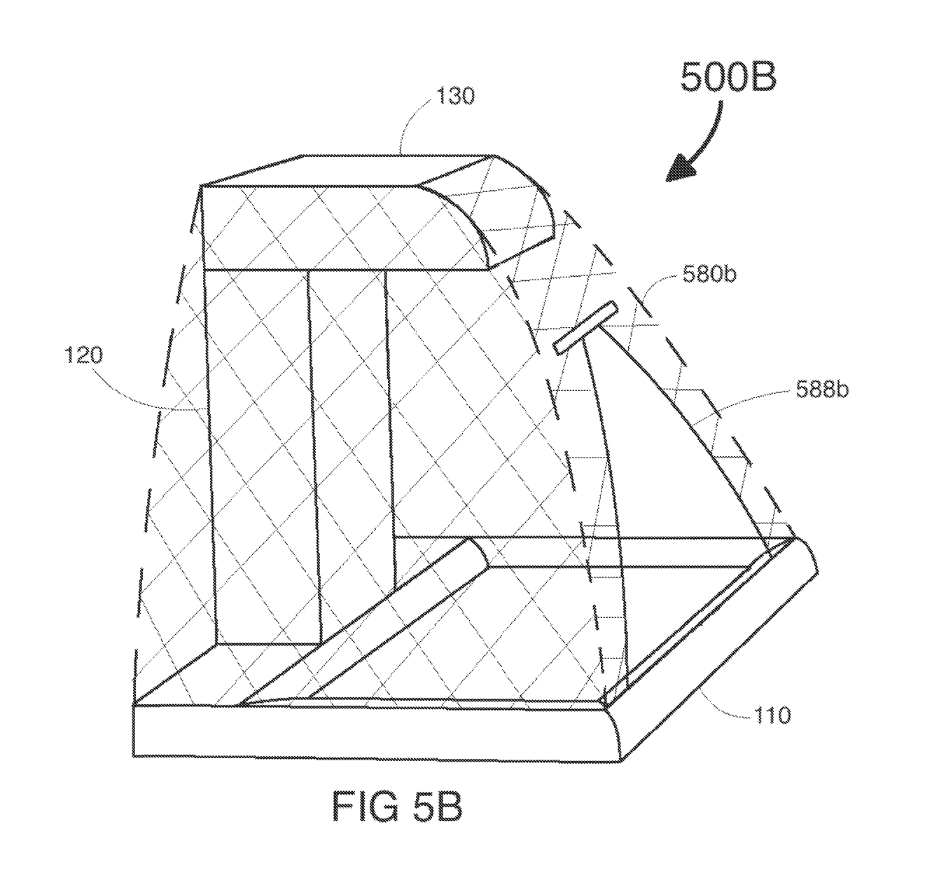

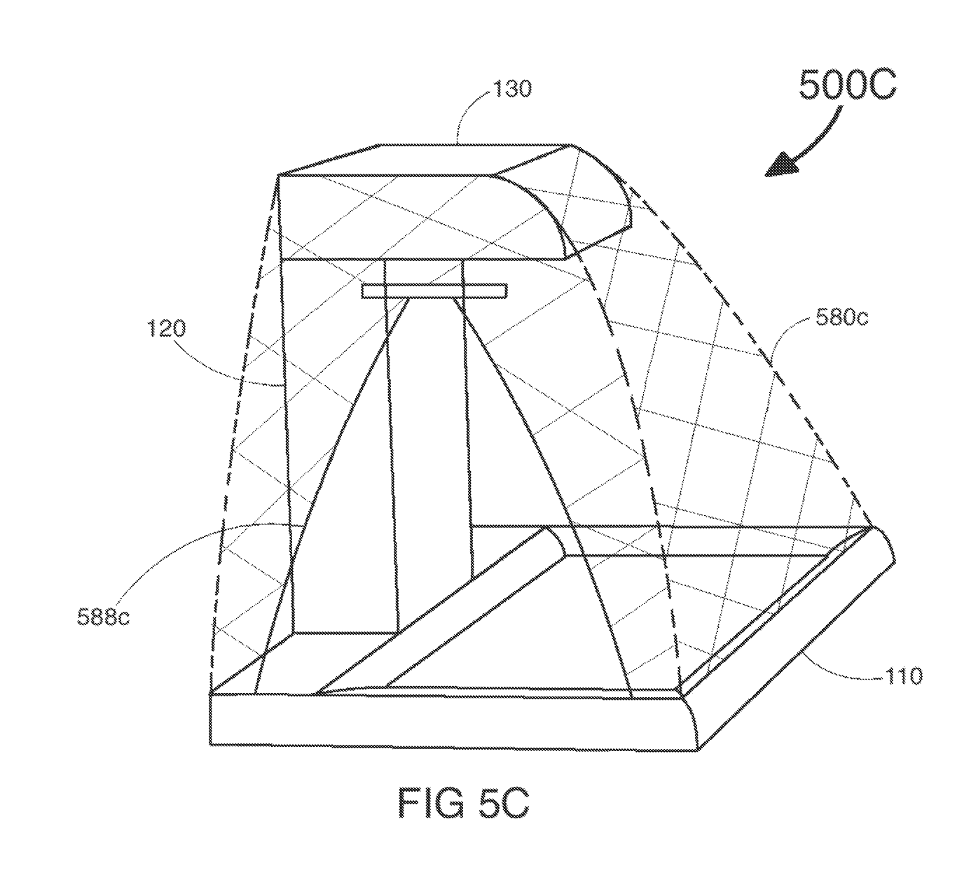

Referring now to FIGS. 5A, 5B and 5C, alternate embodiments of pet habitats 500A, 500B and 500C also include habitat covers 580a, 580b and 580c, respectively. Suitable materials for fabricating covers 580a, 580b and 580c can range from lightweight materials, e.g., mesh-like netting or nylon fabrics, to relatively heavyweight materials, e.g., Thinsulate™ or Gore-Tex™, and combinations thereof

Many optional entryway options for pet habitat covers are possible. For example, habitat cover 580a has a closable front-facing opening 588a that can be secured using a suitable closure mechanism such as a zipper, Velcro strips, or magnetic buttons. Alternatively, habitat cover 580b can have a permanent front-facing opening 588b, while cover 580c can have a side-facing opening 588c.

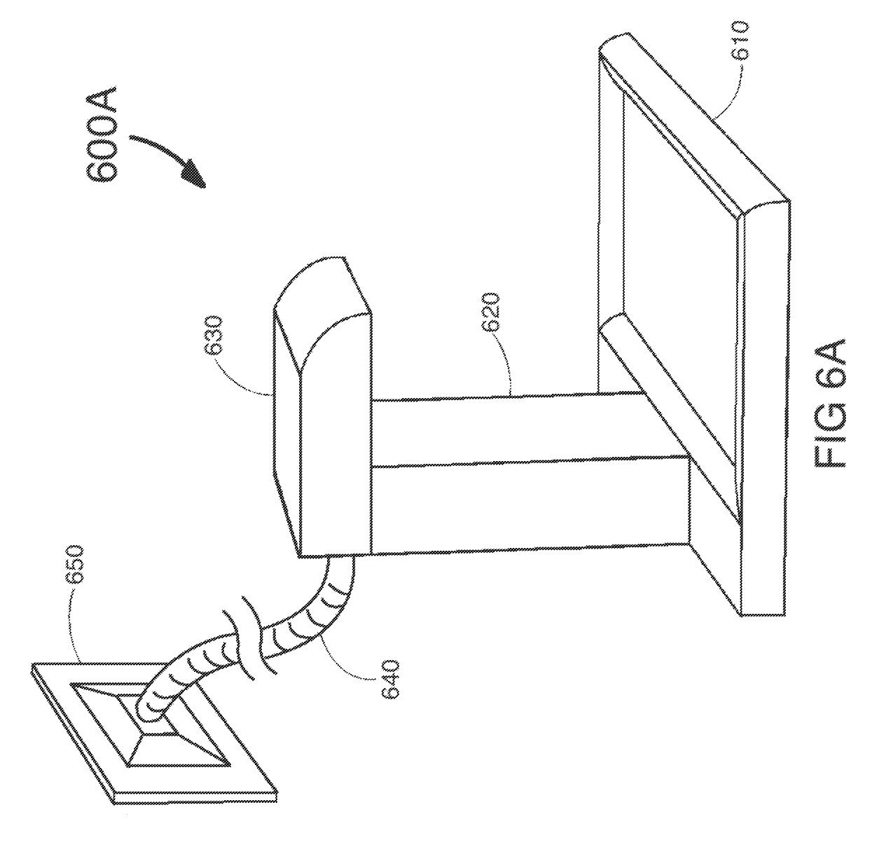

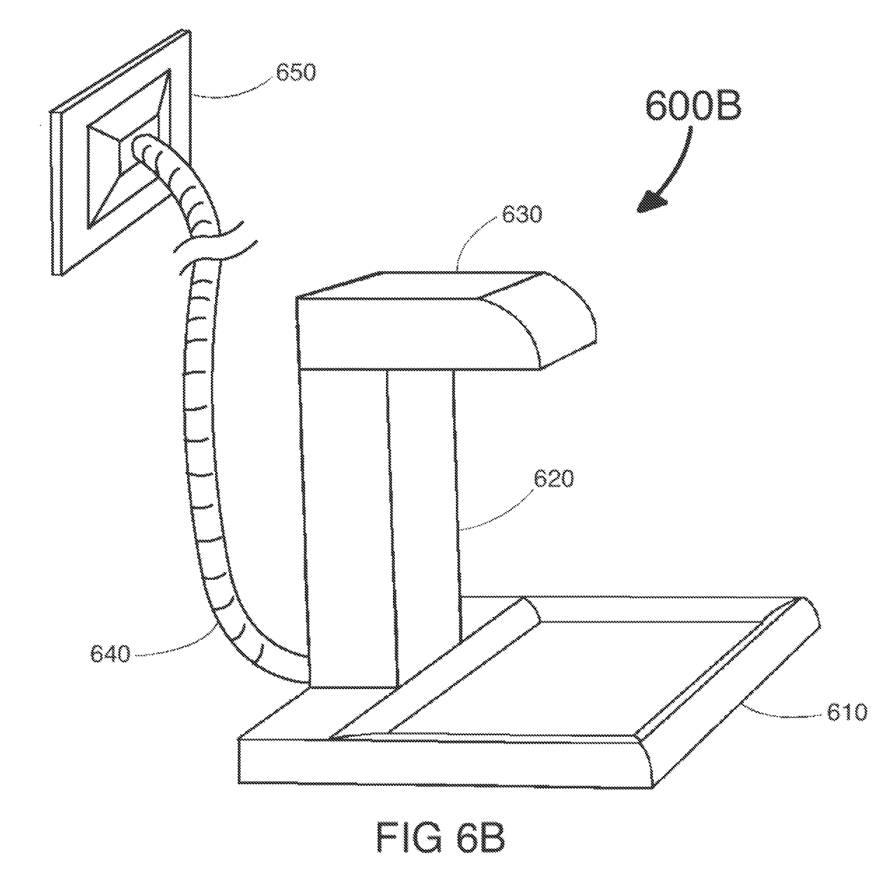

In some embodiments, as illustrated by the exemplary pet habitats 600A and 600B, instead of locating forced-air inlet on the bottom of habitat base 610, the forced-air inlet is located adjacent to base 610 (see FIG. 6B), riser 620 (not shown), or hood 630 (see FIG. 6A). In these embodiments, air hose 640 couples the respective pet habitats to a remote floor forced-air outlet (not shown), a remote ceiling forced-air outlet (not shown), or a remote wall forced-air outlet, e.g., wall register 650. It is also possible for some of these pet habitats to each have multiple forced-air inlets, so they can be easily configured and reconfigured for different building forced-air systems.

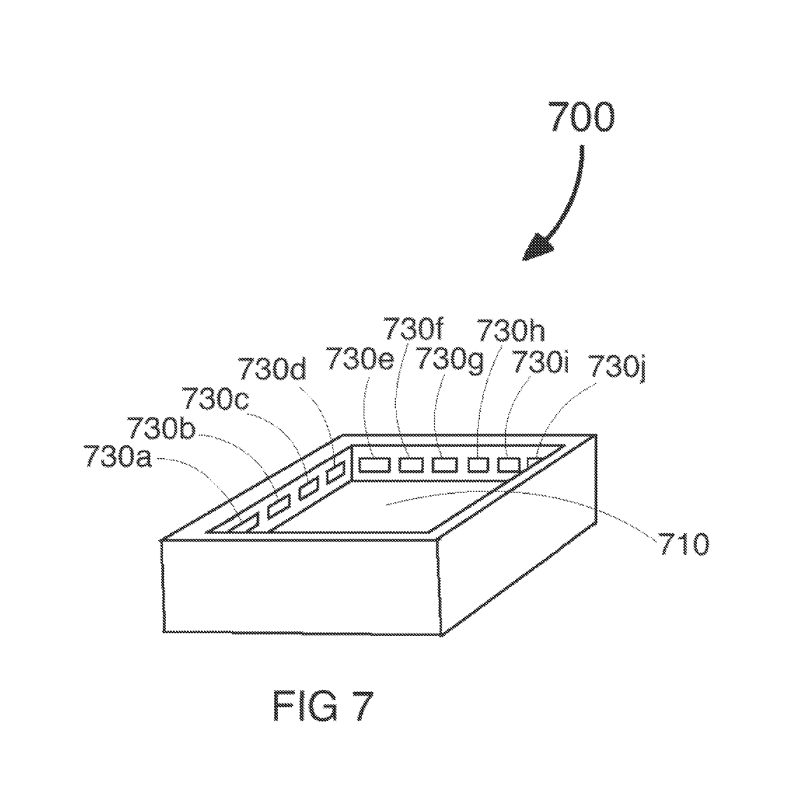

FIG. 7 is a perspective view showing yet another embodiment of an environmentally-controlled pet habitat 700 in accordance with the present invention. Pet habitat 700 is configured to be positioned substantially over an upward facing forced-air outlet such as a floor register (not shown). Air flow can be guided through vents 730a, 730b, 730c . . . 730j and directed at habitat base 710 for comfortably accommodating a pet (not shown).

Many modifications and additions to the described embodiments are also possible. For example, sensors, such as thermometers, weight sensors, smoke detectors, and carbon monoxide detectors can be incorporated into these pet habitats. Visual and audio capability can also be added including background music, smoothing sound recordings (for example soothing sounds of waves landing gently on a beach) and/or mood lighting.

Pet habitats can also be personalized for pet owners and their pets. Examples of personalized features and accessories include logos, decorations, pet toys, ornaments, custom color schemes, bells, wind chimes, scratch pads and massage pads.

Convenience features may also be incorporated into the above described pet habitats. Exemplary convenience features include compartments for storing and/or dispensing disposables such as waste bags and/or expendables such as drinking water and pet treats. Suitable materials for fabricating the above described pet habitats include natural wood, wood composites, plastics, corrugated plastics, fiberboard, biodegradable natural fibers, sheet metals and corrugated metals.

While this invention has been described in terms of several embodiments, there are alterations, modifications, permutations, and substitute equivalents, which fall within the scope of this invention. Hence, it should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. An environmentally-controlled pet habitat useful in association with a forced-air ventilation system of a building, the environmentally-controlled habitat comprising:
a base configured to accommodate a pet;
a forced-air inlet configured to be operatively coupled to a forced-air outlet of a building ventilation system; and
a forced-air guide configured to be operatively coupled to the forced-air inlet and further configured to direct airflow substantially toward the base.

2. The environmentally-controlled pet habitat of claim 1 further comprising a riser configured to support the forced-air guide thereby enabling the forced-air guide to direct airflow substantially downwards toward the base.

3. The environmentally-controlled pet habitat of claim 1 wherein the ventilation system is a heating ventilation and cooling (HVAC) system, and wherein the HVAC system includes at least one of a heater, an air cooler, an air chiller, a blower and an air conditioner.

4. The environmentally-controlled pet habitat of claim 1 further comprising a habitat cover configured to substantially shelter the base.

5. The environmentally-controlled pet habitat of claim 4 wherein the habitat cover is constructed from at least one of a mesh material and an insulating material.

6. The environmentally-controlled pet habitat of claim 4 wherein the habitat cover includes an opening configured to enable the pet to enter and leave the pet habitat.

7. The environmentally-controlled pet habitat of claim 6 wherein the opening is configured to be secured by fasteners such as a magnetic button, a Velcro strip or a zipper.

8. The environmentally-controlled pet habitat of claim 1 further comprising an auxiliary environmental controller.

9. The environmentally-controlled pet habitat of claim 1 wherein the auxiliary environmental controller includes at least one of a fan, a heater, an air conditioner, an air chiller, a humidifier, an air filter, an air freshener, an aromatherapy dispenser, a scent remover, a deodorizer and a disinfector.

10. The environmentally-controlled pet habitat of claim 1 further comprising an air hose configured to direct from the forced-air outlet of the building ventilation system to the forced-air inlet of the pet habitat.

11. The environmentally-controlled pet habitat of claim 1 further comprising at least one of a thermometer, a weight sensor, a smoke detector and a carbon monoxide detector.

12. The environmentally-controlled pet habitat of claim 1 further comprising at least one of a video display, a sound speaker and a mood light.

13. The environmentally-controlled pet habitat of claim 1 further comprising at least one convenience compartment for storing and dispensing at least one disposable item.

14. The environmentally-controlled pet habitat of claim 13 wherein the at least one disposable item is a pet waste bag.

15. The environmentally-controlled pet habitat of claim 1 further comprising at least one convenience compartment for storing and dispensing at least one expendable item.

16. The environmentally-controlled pet habitat of claim 15 wherein the at least one expendable item is drinking water.

17. The environmentally-controlled pet habitat of claim 1 wherein the forced-air guide is a hood.

18. The environmentally-controlled pet habitat of claim 1 wherein the forced-air guide includes at least one vent.
